(19) United States
(12) Patent Application Publication
(10) Pub. No.: US 2004/0190208 A1
(43) Pub. Date: Sep. 30, 2004

(54) Electrostatic discharge protection and methods thereof

(76) Inventor: Maxim Levit, Binyamina (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/396,398

(22) Filed: Mar. 26, 2003

(51) Int. Cl. H02H 9/00

(52) U.S. Cl. 361/56

(57) ABSTRACT

A semiconductor die may include circuitry and a circuit designed to provide protection to the circuitry from an electrostatic discharge coming into the semiconductor die through an input/output pad of the semiconductor die. The circuit may be physically coupled to the input/output pad by a coupling device. When the coupling device is in a first state, the circuit may be electrically coupled to the circuitry and the input/output pad, and when the coupling device is in a second state, the circuit may be electrically decoupled from the circuitry and the input/output pad.

### BACKGROUND OF THE INVENTION

A semiconductor die may have internal circuitry that is sensitive to electrostatic discharges (ESD). In order to protect the internal circuitry from electric currents generated by electrostatic discharges at an input/output (I/O) pad, the semiconductor die may comprise an ESD protection circuit.

The capacitance of the ESD protection circuit may adversely affect the performance of the internal circuitry. This may occur for analog circuitry, radio-frequency circuitry, mixed-signal and/or digital circuitry.

It would be beneficial to maintain the protection of the ESD protection circuit while reducing the adverse effect it may have on the performance of the internal circuitry.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block-diagram illustration of a semiconductor die, according to some embodiments of the present invention; and

FIG. 2 is a simplified block-diagram illustration of an apparatus having installed thereon an integrated circuit including a semiconductor die, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

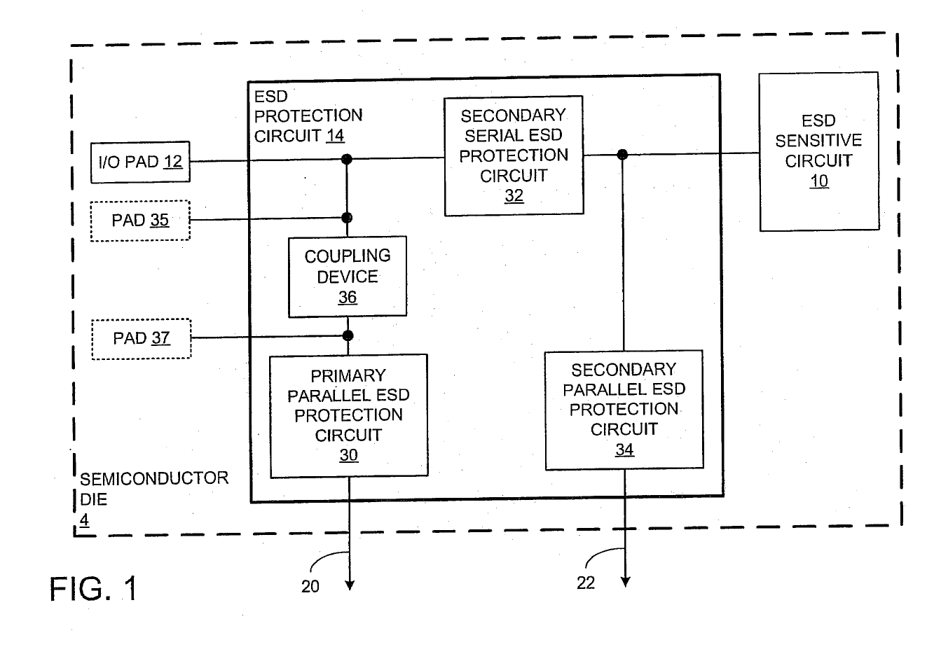

Reference is made to FIG. 1, which is a simplified block-diagram illustration of a semiconductor die 4, according to some embodiments of the present invention.

Although the present invention is not limited in this respect, semiconductor die 4 may be an application specific integrated circuit (ASIC) (such as, for example, analog, radio frequency (RF), low voltage differential signaling (LVDS), digital and/or mixed-signal), an application specific standard product (ASSP) (such as, for example, analog, RF, LVDS, digital and/or mixed-signal), or a general purpose standard product (such as, for example, analog, RF, LVDS, digital and/or mixed-signal and the like).

Semiconductor die 4 may comprise electrostatic discharge (ESD) sensitive circuitry 10, an input/output (I/O) pad 12, an ESD-protection circuit 14, conductors 20 and conductors 22. I/O pad 12 may be coupled to ESD-sensitive circuitry 10 through ESD protection circuit 14.

If an electrostatic discharge were to become coupled to I/O pad 12 by some conductive medium an ESD electric current would be created. The ESD electric current may be of sufficient strength to cause temporary or permanent damage to ESD-sensitive circuitry 10 if it were to reach ESD-sensitive circuitry 10. ESD-protection circuit 14 may protect ESD-sensitive circuitry 10 by routing the ESD electric current created by the electrostatic charge to conductors 20 and 22 and out of semiconductor die 4 so that it does not reach ESD-sensitive circuitry 10.

The electrostatic discharges to which a semiconductor die is exposed may depend upon the environment of the semiconductor die. For example, during production, storage and handling of the semiconductor die, during testing of the semiconductor die prior to its packaging in an integrated circuit, during testing of the semiconductor die once packaged in the integrated circuit, and during installation of the integrated circuit in an apparatus, the semiconductor die may be exposed to electrostatic discharges that are potentially harmful to ESD-sensitive circuitry 10.

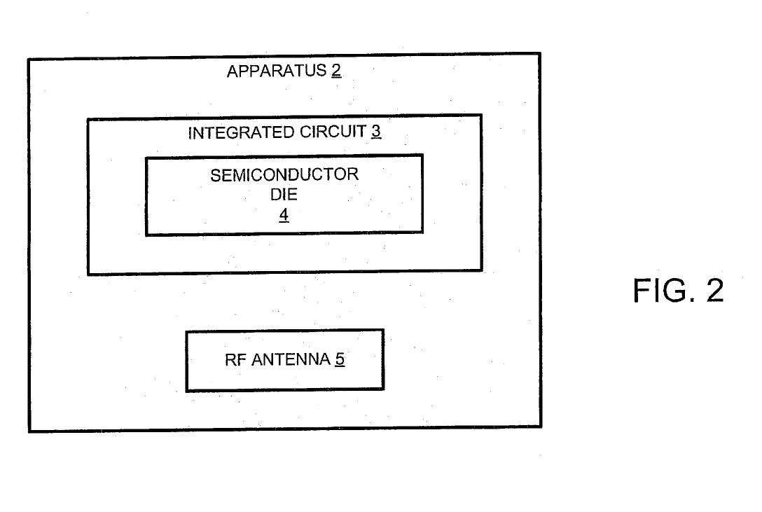

Reference is made briefly to FIG. 2, which is a simplified block-diagram of an apparatus 2 having installed thereon an integrated circuit 3 comprising semiconductor die 4. Although the present invention is not limited in this respect, apparatus 2 may also include an RF antenna 5.

The apparatus may be a motherboard of a computer, an add-in board such as, for example, a Personal Computer Memory Card International Association (PCMCIA) board, a system board, and the like, although the present invention is not limited in this respect. The computer may be, for example, a portable computer such as a laptop or notebook computer or a handheld personal computer, or may be a desktop computer, although the present invention is not limited in this respect. The portable computer may comprise an infrared interface port and/or wireless interface port. The apparatus may be a cellular telephone, a pager, a digital television set, or any other type of RF equipment.

In such environments, the conductive medium through which an electrostatic discharge may be coupled to I/O pad 12 may be any or any combination of the following: air, a part of a human body, a test probe, a socket, a connector, a conducting wire, a wire bond, a rigid printed circuit board (PCB), a flexible PCB, a PCB trace, a pad of another integrated circuit or semiconductor device, or any other conducting element that comes in contact with I/O pad 12, although the present invention is not limited in this respect.

In order to handle such potentially harmful electrostatic discharges, ESD protection circuit 14 may comprise a primary parallel ESD protection circuit 30, a secondary serial ESD protection circuit 32 and a secondary parallel ESD protection circuit 34. Primary parallel ESD protection circuit 30 may be coupled to conductors 20 and secondary parallel ESD protection circuit 34 may be coupled to conductors 22. Examples of protection circuits 30, 32 and 34 are known in the art, and may comprise one or more diodes, one or more resistors, one or more transistors, such as, for example, grounded-gate negative-channel metal oxide semiconductor (NMOS) transistors, or any combination thereof.

Primary parallel ESD protection circuit 30 may route a significant portion of the ESD electric current caused by an electrostatic discharge to conductors 20 and out of semiconductor die 4. Secondary ESD protection circuits 32 and 34 may route a significant part of the remaining portion of the ESD electric current to conductors 22 and out of semiconductor die. The portion of the ESD electric current reaching ESD-sensitive circuitry 10 may be sufficiently small as to pose little or no danger to ESD-sensitive circuitry 10,

In order to provide the protection described hereinabove, primary parallel ESD protection circuit 30 may comprise components that are larger than the components of secondary parallel ESD protection circuit 34. Consequently, primary parallel ESD protection circuit 30 may have a capacitance sufficiently large to adversely affect the performance of ESD-sensitive circuitry 10. For example, ESD-sensitive circuitry 10 may comprise analog and/or radio-frequency circuitry whose performance may be degraded by the capacitance of primary parallel ESD protection circuit 30.

Once the integrated circuit in which a semiconductor die has been packaged is installed in an apparatus, the semiconductor die may be less exposed to electrostatic discharges, since other components of the apparatus may shield the semiconductor die from electrostatic discharges.

Once installed in an apparatus, the conductive medium through which an electrostatic discharge may be coupled to I/O pad 12 may be any or any combination of the following: a socket, a connector, a conducting wire, a wire bond, a rigid printed circuit board (PCB), a flexible PCB, a PCB trace, a pad of another integrated circuit or semiconductor device, and the like, although the present invention is not limited in this respect.

According to some embodiments of the present invention, ESD protection circuit 14 may comprise a coupling device 36 that may physically couple primary parallel ESD protection circuit 30 to I/O pad 12. I/O pad 12 may also be coupled to secondary serial ESD protection circuit 32. Secondary serial ESD protection circuit 32 may be coupled to secondary parallel ESD protection circuit 34 and to ESD-sensitive circuitry 10.

Coupling device 36 may have a first state and a second state. When coupling device 36 is in the first state, primary parallel ESD protection circuit 30 may be electrically coupled to ESD-sensitive circuitry 10 and I/O pad 12. It may be appropriate to have coupling device 36 in its first state when the environment of semiconductor die 4 is such that semiconductor die 4 is exposed to potentially harmful electrostatic discharges. For example, such an environment may be the manufacturing environment of the semiconductor die, the storage, handling or testing environment before the semiconductor die is packaged in an integrated circuit, the testing environment before the integrated circuit in which the semiconductor die is packaged is installed in an apparatus, or the installation environment. With coupling device 36 in its first state, in the event that an electrostatic discharge is coupled to I/O pad 12 via a conductive medium and generates an ESD electric current, a significant portion of that current will be routed by primary parallel ESD protection circuit 30 to conductors 20 and out of semiconductor die 4.

When coupling device 36 is in the second state, primary parallel ESD protection circuit 30 may be electrically decoupled from ESD-sensitive circuitry 10 and I/O pad 12. It may be appropriate to have coupling device 36 in its second state when the environment of semiconductor die 4 is such that semiconductor die 4 is less exposed to potentially harmful electrostatic discharges. For example, such an environment may be the testing environment before the integrated circuit in which the semiconductor die is packaged is installed in an apparatus, or the environment when the integrated circuit is already installed in the apparatus. With coupling device 36 in its second state, in the event that an electrostatic discharge is coupled to I/O pad 12 via a conductive medium and generates an ESD electric current, the current will reach secondary serial ESD protection circuit 32 and secondary parallel ESD protection circuit 34. Therefore, secondary serial ESD protection circuit 32 and secondary parallel ESD protection circuit 34 may be designed to handle and route to conductors 22 enough of the ESD electric current expected in such an environment, so that the remaining portion of the current poses little or no harm to ESD-sensitive circuitry 10.

When coupling device 36 is in its second state, the capacitance of primary parallel ESD protection circuit 30 is unable to adversely affect the performance of ESD-sensitive circuitry 10 since primary parallel ESD protection circuit 30 is electrically decoupled from ESD-sensitive circuitry 10 and I/O pad 12. Moreover, secondary serial ESD protection circuit 32 and secondary parallel ESD protection circuit 34 may be designed so as not to hinder the performance of ESD-sensitive circuitry 10.

Although the present invention is not limited in this respect, coupling device 36 may be a fuse. In its first state, the fuse may be a substantially conductive fuse. In its second state, the fuse may be a substantially non-conductive fuse. For example, the fuse may be a substantially conductive fuse during manufacturing and testing of the semiconductor die. After the integrated circuit in which the semiconductor die is packaged has been installed in an apparatus, the fuse may be put in its substantially non-conducting state. For example, the fuse may be exposed to a large current for a short period of time (for example, approximately 20 mA for approximately 100 microseconds). The large current may-be provided by a nominal voltage, for example 1.2 V, or by a higher-than-nominal voltage, for example 2.5 V. This operation is known as fuse programming, fuse burning or fuse blowing. In the low-resistance state, the fuse resistance may be approximately 20-50 ohm, for example, and in the high-resistance state, the fuse resistance may be approximately 1000 ohm or more, although other resistances are also within the scope of the present invention. Alternatively, an array of fuses connected in parallel may be used.

For example, coupling device may be connected to two pads 35 and 37, coupled to coupling device 36 specifically for the purpose of programming the fuse. When the integrated circuit in which the semiconductor die is packaged is installed in an apparatus, one voltage level may be supplied to one of the pads and another voltage level to the other of the pads for the fuse blowing operation. After the operation is completed and the fuse is substantially non-conducting, these pads may be disconnected and may remain disconnected during the normal operation of the integrated circuit.

Although the present invention is not limited in this respect, coupling device 36 may be a pass-gate that is substantially conducting in its first state and substantially non-conducting in its second state. A control signal (not shown) may be coupled to the pass-gate to switch its state from conducting to non-conducting and vice versa. Such a control signal may enable the pass-gate to electrically couple primary parallel ESD protection circuit 30 to I/O pad 12 and ESD-sensitive circuitry 10 even after installation of an integrated circuit in which the semiconductor die is packaged in an apparatus, for example, for the purpose of testing.

It will be appreciated by persons of ordinary skill in the art that a system of digital circuitry will have constraints on the permissible capacitance in order that the slew rate of signal changes is sufficiently high to identify ones and zeros in a consistent manner at a defined frequency of the digital signal. By putting coupling device 36 into its second state and electrically decoupling primary parallel ESD protection circuit 30 from ESD-sensitive circuitry 10, the overall capacitance of semiconductor die may be reduced. This may make it easier for a system designer to satisfy the system constraints on the permissible capacitance. For example, in a digital system with a given set of components, having components with a lower capacitance may enable communication between the components at a higher frequency. In another example, having digital components with a lower capacitance may enable a system designer to include more of such components in the system.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A semiconductor die comprising:
circuitry; and
a circuit designed to provide protection to the circuitry from an electrostatic discharge coming into the semiconductor die through an input/output pad of the semiconductor die, wherein the circuit is electrically decoupled from the circuitry and from the input/output pad.

2. The semiconductor die of claim 1, further comprising a substantially non-conducting fuse physically coupling the circuit to the input/output pad.

3. The semiconductor die of claim 1, further comprising a substantially non-conducting pass-gate physically coupling the circuit to the input/output pad.

4. A semiconductor die comprising:
circuitry;
an electrostatic discharge protection circuit; and
a programmable fuse electrically coupling the electrostatic discharge protection circuit to the circuitry and to an input/output pad of the semiconductor die.

5. The semiconductor die of claim 4, further comprising one or more additional pads coupled to said programmable fuse.

6. The semiconductor die of claim 4, further comprising an additional electrostatic discharge protection circuit electrically coupled to the circuitry and to the input/output pad.

7. A semiconductor die comprising:
circuitry;
an electrostatic discharge protection circuit; and
a device physically coupling the electrostatic discharge protection circuit to an input/output pad of the semiconductor die, the device having a first state and a second state,
wherein when the device is in the first state, the electrostatic discharge protection circuit is electrically coupled to the circuitry and the input/output pad, and when the device is in the second state, the electrostatic discharge protection circuit is electrically decoupled from the circuitry and the input/output pad.

8. The semiconductor die of claim 7, wherein in the first state the device is a substantially conductive fuse, and in the second state the device is a substantially non-conductive fuse.

9. The semiconductor die of claim 7, wherein the device is a pass-gate that is substantially conducting in the first state and is substantially non-conducting in the second state.

10. The semiconductor die of claim 7, further comprising an additional electrostatic discharge protection circuit electrically coupled to the circuitry and to the input/output pad, wherein when the device is in the second state, the additional electrostatic discharge protection circuit does not hinder a desired performance of the circuitry.

11. The semiconductor die of claim 7, further comprising an additional electrostatic discharge protection circuit electrically coupled to the circuitry and to the input/output pad, wherein when the device is in the second state, the additional electrostatic discharge protection circuit is able to protect the circuitry from an electrostatic discharge coming into the semiconductor die through the input/output pad.

12. An apparatus having installed thereon an integrated circuit comprising:
a semiconductor die including at least;
circuitry; and
a circuit designed to provide protection to the circuitry from an electrostatic discharge coming into the semiconductor die through an input/output pad of the semiconductor die, wherein the circuit is electrically decoupled from the circuitry and from the input/output pad.

13. The apparatus of claim 12, further comprising a substantially non-conducting fuse physically coupling the circuit to the input/output pad.

14. The apparatus of claim 12, further comprising a substantially non-conducting pass-gate physically coupling the circuit to the input/output pad.

15. The apparatus of claim 12, further comprising an additional electrostatic discharge protection circuit electrically coupled to the circuitry and to the input/output pad.

16. An apparatus comprising:
a radio frequency antenna; and
a semiconductor die including at least:
circuitry; and
a circuit designed to provide protection to the circuitry from an electrostatic discharge coming into the semiconductor die through an input/output pad of the semiconductor die, wherein the circuit is electrically decoupled from the circuitry and from the input/output pad.

17. The apparatus of claim 16, further comprising a substantially non-conducting fuse physically coupling the circuit to the input/output pad.

18. The apparatus of claim 16, further comprising a substantially non-conducting pass-gate physically coupling the circuit to the input/output pad.

19. The apparatus of claim 16, further comprising an additional electrostatic discharge protection circuit electrically coupled to the circuitry and to the input/output pad.

20. A method comprising:
electrically decoupling circuitry of a semiconductor die from a circuit of said semiconductor die, said circuit designed to provide protection to the circuitry from an electrostatic discharge coming into said semiconductor die through an input/output pad of the semiconductor die.

21. The method of claim 20, wherein electrically decoupling said circuitry from said circuit is irreversible.

22. The method of claim 21, wherein electrically decoupling said circuitry from said circuit comprises causing a fuse physically coupling said circuitry to said circuit to become substantially non-conducting.

23. The method of claim 20, wherein electrically decoupling said circuitry from said circuit is reversible.

24. The method of claim 23, wherein electrically decoupling said circuitry from said circuit comprises switching the state of a substantially conducting pass-gate physically coupling said circuitry to said circuit to a substantially non-conducting state.
